(19) United States
(12) Patent Application Publication
(10) Pub. No.: US 2019/0269486 A1
(43) Pub. Date: Sep. 5, 2019

(54) Teeth-Cleaning System, Main Body, and Holder for Dental Floss

(71) Applicant: GSTS Innovation GmbH, Mering (DE)

(72) Inventors: Tomás Alberto Joachi Schaefer, Dorfen (DE); Stefan Josef Gibisch, Mering (DE)

(21) Appl. No.: 16/256,431

(22) Filed: Jan. 24, 2019

(30) Foreign Application Priority Data
Mar. 1, 2018 (DE) 10 2018 104 695.2

(51) Int. Cl. A61C 15/04

(52) U.S. Cl. CPC A61C 15/046

(57) ABSTRACT

The invention relates to a teeth-cleaning system (2) comprising a holder (12) for dental floss (18), which includes two mutually spaced brackets (19) and dental floss (18) held between the two brackets (19), and comprising an, in particular U-shaped or annular, main body (1) to be slid onto a finger, which includes a recess (4) situated in the longitudinal direction (3) of the main body (1) for accommodating a fingertip. The brackets (19) extend essentially transversely with respect to the longitudinal direction (3) of the main body (1) and a first grip surface (9) is situated at least on each of the two sides of the main body (1), which is provided for controlling the movement of the dental floss (18) in the mouth with the aid of the fingers adjacent to the main body (18). The invention also relates to a main body (1) and a holder (12).

The present invention relates to a teeth-cleaning system comprising a holder for dental floss, which includes two mutually spaced brackets and a dental floss held between the two brackets, and comprising an, in particular U-shaped or annular, main body to be slid onto a finger, which includes a recess situated in the longitudinal direction of the main body for accommodating a fingertip.

Moreover, the invention relates to a main body for a teeth-cleaning system, in particular, according to one of the preceding claims, which is designed, in particular, to be U-shaped or annular in order to be slid onto a finger, and which comprises a recess situated in the longitudinal direction of the main body for accommodating a fingertip.

Moreover, the invention relates to a holder for dental floss for a teeth-cleaning system, in particular according to one of the preceding claims, comprising two mutually spaced brackets and dental floss held between the two brackets.

Devices for holding dental floss are sufficiently known from the related art. For example, U.S. Pat. No. 5,222,510 A describes an open ring comprising two brackets, between which dental floss is clamped. Devices of this type have proven to be impractical to handle, however.

U.S. Pat. No. 5,893,379 A describes a teeth-cleaning system which is guided with the aid of two fingers. This system takes up a lot of space in the oral cavity and, therefore, is difficult to handle. The two fingers also make it very difficult to keep the dental floss taut during insertion into the interdental space.

U.S. Pat. No. 5,881,745 A is the closest prior art. The aforementioned document discloses a teeth-cleaning system comprising a holder for dental floss, which includes two mutually spaced brackets and dental floss held between the two brackets. A main body is intended to be slid onto a finger and comprises a recess situated in the longitudinal direction of the main body for accommodating a fingertip. The main body is designed in the shape of a thimble. A second thimble or at least a part of a second thimble is provided for controlling the teeth-cleaning system in the mouth. The control can therefore take place using only one finger, however, and is therefore inaccurate and nevertheless takes up a lot of space in the oral cavity.

The problem addressed by the present invention is therefore that of providing a system for cleaning interdental spaces, the application of which has been simplified.

The problem is solved by the features of the independent patent claims. Further advantageous embodiments result from the dependent claims and the drawings.

The invention relates to a teeth-cleaning system comprising a holder for dental floss. The teeth-cleaning system comprises two mutually spaced brackets and dental floss held between the two brackets. The dental floss is designed to be introduced into the interdental space, and so the interdental space can be cleaned. Moreover, the teeth-cleaning system comprises a main body to be slid onto a finger. The main body comprises a recess in the longitudinal direction for accommodating a fingertip and is preferably designed to be U-shaped or annula The longitudinal direction of the main body preferably extents from a first recess opening up to a second recess opening, through which the finger can be guided into the recess. The recess can also comprise only one recess opening, and so the main body is essentially thimble-shaped.

The brackets of the holder extend essentially transversely to the longitudinal direction of the main body, and so the brackets and the main body are preferably situated at an angle with respect to one another. A grip surface is situated on each of the two sides of the main body, which is provided for controlling the movement of the dental floss in the mouth with the aid of the fingers adjacent to the main body. The grip surfaces preferably extend in the longitudinal direction of the main body.

In this way, the finger can be inserted into the oral cavity essentially in parallel to the masticatory surface relief and pressed downward in order to insert the dental floss into the interdental space. The grip surfaces enable the teeth-cleaning system to be moved and controlled in the oral cavity, and so the dental floss removes contaminants from the interdental space in a targeted manner. Preferably, the brackets extend obliquely with respect to the longitudinal direction of the main body.

A further second grip surface for controlling the movement of the dental floss in the mouth, with the aid of the thumb, is advantageously provided on the side of the main body opposite to the brackets. In addition to the lateral guidance with the aid of the two first grip surfaces, pressure can be applied onto the teeth-cleaning system by the index finger with the aid of this further grip surface. Closely adjacent teeth usually make it difficult to insert the dental floss into the interdental space. The controlled guidance of the teeth-cleaning system with the aid of the grip surfaces facilitates the introduction of the dental floss, since the pressure and the movement can take place in a targeted manner.

Yet another advantage is achieved when at least one of the grip surfaces forms a surface which is, in particular, wing-like and projects over the main body. Therefore, a preferably large grip surface for the finger is provided, without proportioning the teeth-cleaning system to be too large overall to be able to be comfortably positioned in the oral cavity.

It is advantageous when at least one of the grip surfaces includes a non-slip, in particular, curved, perforated, and/or ribbed surface. The feel of the grip surfaces improves the handling of the teeth-cleaning system, since a good hold is ensured even when the surface is possibly wet.

It is advantageous when the holder and the main body are designed as one piece or multi-pieced. The dental floss should be changed regularly, for hygiene reasons. In the case of a multi-pieced design of the teeth-cleaning system, in particular, due to a holder of the dental floss, which is separate from the main body, it is possible to replace the holder together with the dental floss. Alternatively, the holder and the main body can be designed as one piece, wherein the dental floss is preferably detachably connected to the holder, and so the dental floss can be replaced independently of the holder. The teeth-cleaning system is therefore modularly designed in order to implement the replacement of the dental floss as easily as possible. In this case, the dental floss can also be fixedly connected to the teeth-cleaning system, of course, which is then completely discarded after every teeth cleaning.

It is an advantage when the main body comprises a slot. The slot is preferably designed for accommodating at least one part of the holder. Moreover, it is conceivable to tension the slot in such a way that the recess is enlarged or reduced in size in order to be able to adapt the teeth-cleaning system to different finger sizes.

A fastening system advantageously connects the holder and the main body to one another. Due to the fastening system, the holder and the main body can be detachably connected to one another.

It is advantageous when the holder and the main body each comprise a part of the fastening system. The two parts are designed to be complementary to one another in such a way that the dental floss held by the holder is pre-tensioned when the holder and the main body are connected to one another.

Moreover, it is advantageous when the fastening system has a form-locking and/or force-locked connection. Preferably, the fastening system comprises a fastening rail and a fastening carriage, wherein the fastening rail is situated on the holder and the fastening carriage is situated on the main body. The fastening carriage can also be situated on the holder and the fastening rail can also be situated on the main body. Moreover, the fastening system can have a magnetic, threaded, plug-in, adhesive, hook and loop connection, and/or a snap-in connection, and so the holder and the main body can be detachably connected to one another.

It is an advantage when a releasable locking mechanism secures the connection between the holder and the main body. The locking mechanism can be situated, on the one hand, on the holder and, on the other hand, on the main body. When the locking mechanism is secured, it is ensured, in particular, during the application in the oral cavity, that the holder cannot be separated from the main body. In this way, it is ensured that neither the holder nor the main body can be swallowed.

The fastening rail and the fastening carriage advantageously taper conically in the longitudinal and/or transverse direction of the main body. Due to the conical design of the fastening rail and of the fastening carriage, they can be connected to one another in a guided manner. Moreover, it is possible to establish the tension of the dental floss by way of the selected insertion pressure. The further the fastening carriage is introduced into the fastening rail and, therefore, the smaller the remaining taper portion essentially is, the more tightly the dental floss is tensioned between the brackets. The angled guidance provides an increased pretension.

Moreover, it is advantageous when the fastening rail and/or the fastening carriage comprise/comprises lateral, in particular, U-shaped and/or dovetail-shaped guide surfaces.

It is advantageous when the guide surfaces of the fastening rail and of the fastening carriage are not parallel to one another in the non-assembled state, and so the holder, which is connected to the main body, is spread apart in the assembled state in such a way that the dental floss is tensioned between the brackets.

It is an advantage when a retaining element, in particular, a thread, safeguards the holder and/or the main body against being swallowed.

A stop is advantageously situated on the holder and/or on the main body, in an area between the two brackets, the dental floss, and the main body, and so the depth of the introduction of the dental floss into an interdental space is limited in a vertical direction. The stop is selected in such a way that the dental floss preferably cannot or can only slightly come into contact with the gums, and so bleeding of the gums and injuries are prevented. The height of the stop can vary depending on the group of persons for whom the teeth-cleaning system is intended.

It is advantageous when the stop is formed by the surface of the main body or of the holder opposite the dental floss and the depth of the introduction is determined by the length of the brackets. The length of the brackets is preferably established by the area, which extends from the fastening area of the dental floss up to the stop. When the stop is formed by the surface of the main body opposite the dental floss, the holder and the main body are preferably designed as one part. Alternatively, an inner side of the holder can establish the stop.

The holder and/or the main body advantageously comprise/comprises a fastening element for fastening dental floss. The fastening element can be designed in the shape of a cone, for example, and can be equipped with a clamping slot, and so the ends of the dental floss can be wound around the fastening element several times and fixed in the clamping slot. It is also conceivable that the clamping slot is formed in the brackets themselves, and so the dental floss is clamped directly into the brackets.

In order to designate a certain size and/or dental floss, it is advantageous when the holder and/or the main body include/includes a coding, in particular, a color coding. Teeth-cleaning systems intended for children can include motifs, for example, whereby the teeth-cleaning system may become more attractive for children. It is also conceivable to select different colors of the main body and/or the holder depending on the finger size for which the teeth-cleaning system is designed.

The invention also relates to a main body for a teeth-cleaning system. The teeth-cleaning system is preferably designed according to the preceding description or the following description. The main body is designed, in particular, to be U-shaped or annular in order to be slid onto a finger and comprises a recess situated in the longitudinal direction of the main body for accommodating a fingertip. The recess preferably extends from a first recess opening to a second recess opening. It is also conceivable that the recess comprises only one recess opening, and so the main body is essentially thimble-shaped. The longitudinal direction basically extends through the center of the recess or in parallel to its axis of symmetry.

A grip surface is situated at least on each of the two sides of the main body, which is provided for controlling the movement of dental floss in the mouth with the aid of the fingers adjacent to the main body. The grip surface preferably extends in the longitudinal direction. As a result, it is possible to control the main body and, therefore, the entire teeth-cleaning system essentially in three dimensions. The movement control takes place in a tactile manner. Preferably, the two grip surfaces are operated by the thumb and the middle finger, and so the index finger stabilizes and the pressing, thrusting, and twisting movements can be enhanced. When the main body and the teeth-cleaning system are introduced into the oral cavity, the grip surfaces are preferably oriented on the main body in the direction of the mouth. The grip surfaces therefore preferably project over the main body in the longitudinal direction.

In this case, it is an advantage when a third grip surface is provided between the two lateral first grip surfaces for controlling the movement of the dental floss in the mouth with the aid of the thumb. The index finger preferably engages on the third grip surface in order to apply pressure onto the main body, and so the dental floss of the teeth-cleaning system can be introduced into the interdental space and guided.

It is also advantageous when at least the two lateral grip surfaces form a surface which is, in particular, wing-like and/or projects over the main body. As a result, the fingers can ergonomically grip the main body.

Advantageously, a first part of a form-locking and/or force-locked fastening system for accommodating a holder for dental floss is formed on the main body for connecting the main body to a holder for dental floss. The part of the fastening system is preferably a fastening rail or a fastening carriage, a portion of a magnetic, threaded, plug-in, adhesive, hook and loop connection, and/or a part of a snap-in connection.

It is advantageous when the recess is designed to be conical and/or flattened, and so the cleaning system can be held on the finger in a rotatably fixed manner. Preferably, the first recess opening is larger than the second recess opening, and so an inner surface of the recess conically tapers. In order to be able to hold the main body on the finger in a rotatably fixed manner, the inner surface of the recess can be formed from several surface segments situated at an angle with respect to one another.

It is advantageous when the main body includes a slot, in particular, for accommodating the holder and/or for adaptation to different finger sizes. The slot preferably extends in the longitudinal direction of the main body. It is conceivable that the main body comprises multiple slots and, therefore, is flexibly designed in order to be adaptable to different finger sizes.

The main body is advantageously U-shaped or is designed, on its periphery, as a closed ring or an open ring and/or as a thimble.

The invention also relates to a holder for dental floss for a teeth-cleaning system. The teeth-cleaning system is preferably designed according to the preceding description or the following description. The holder comprises two mutually spaced brackets and dental floss held between the two brackets.

The holder comprises a second part of a form-locking and/or force-locked fastening system for connecting the holder to a main body of the teeth-cleaning system. The second part is preferably a fastening carriage or a fastening rail and/or a part of a magnetic, threaded, plug-in, adhesive, hook and loop connection, or snap-in connection.

Due to the holder, it is permitted to remove the dental floss from the teeth-cleaning system without the need to replace the entire teeth-cleaning system.

Advantageously, the fastening system is situated longitudinally or transversely with respect to the orientation of the dental floss.

According to the invention, the dental floss is tensioned between the two brackets when the holder is fastened to the main body.

It is advantageous when a stop is situated in an area formed between the two brackets, the dental floss, and an underside of the fastening carriage, and so an introduction of the dental floss into an interdental space is limited in a vertical direction.

Further advantages of the invention are described in the following exemplary embodiments. Wherein:

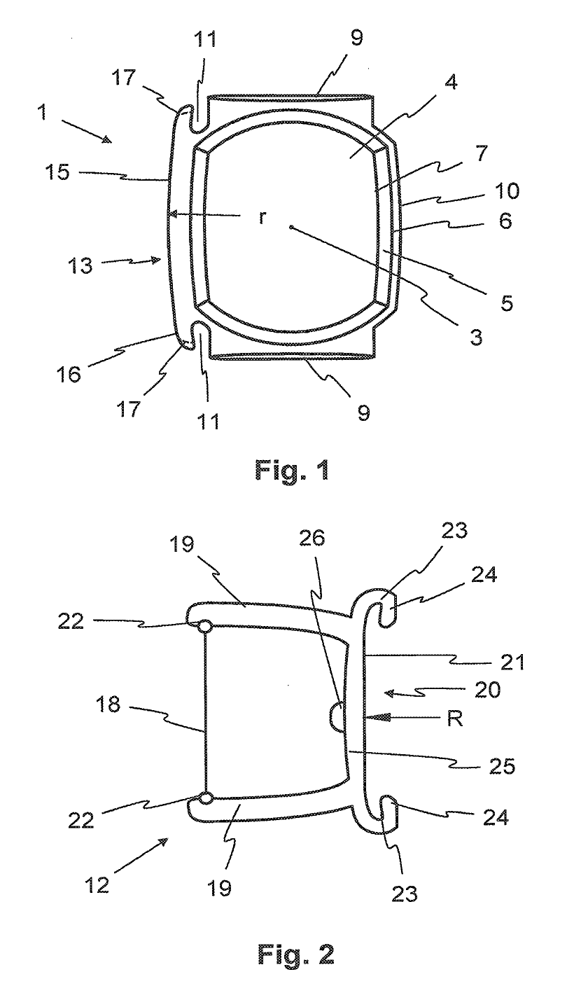

FIG. 1 shows a top view of a main body according to a first exemplary embodiment,

FIG. 2 shows a top view of a holder according to an exemplary embodiment,

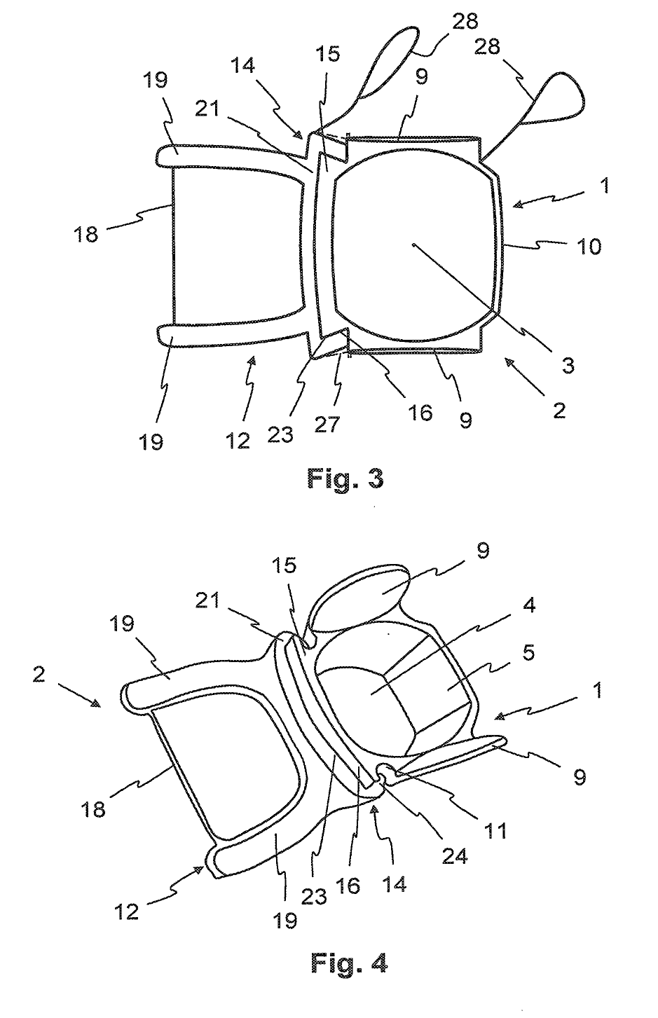

FIG. 3 shows a top view of a teeth-cleaning system comprising a main body and a holder according to an alternative exemplary embodiment,

FIG. 4 shows a perspective representation of the teeth-cleaning system according to a further exemplary embodiment,

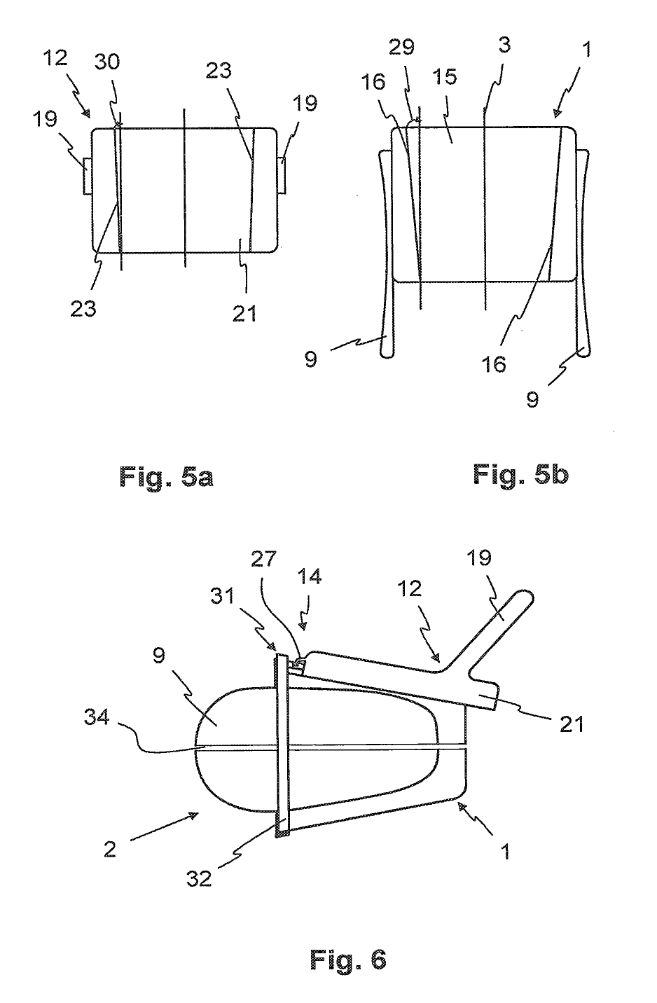

FIG. 5a shows a front view of the holder,

FIG. 5b shows a front view of the main body.

FIG. 6 shows a side view of the teeth-cleaning system according to a further embodiment,

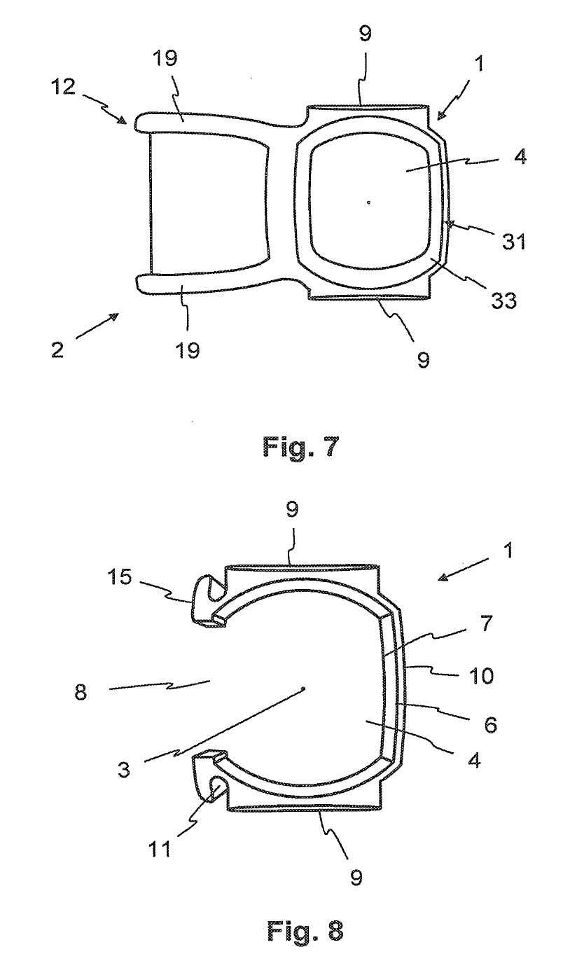

FIG. 7 shows a top view of the teeth-cleaning system according to an additional exemplary embodiment,

FIG. 8 shows a top view of the main body according to a further exemplary embodiment,

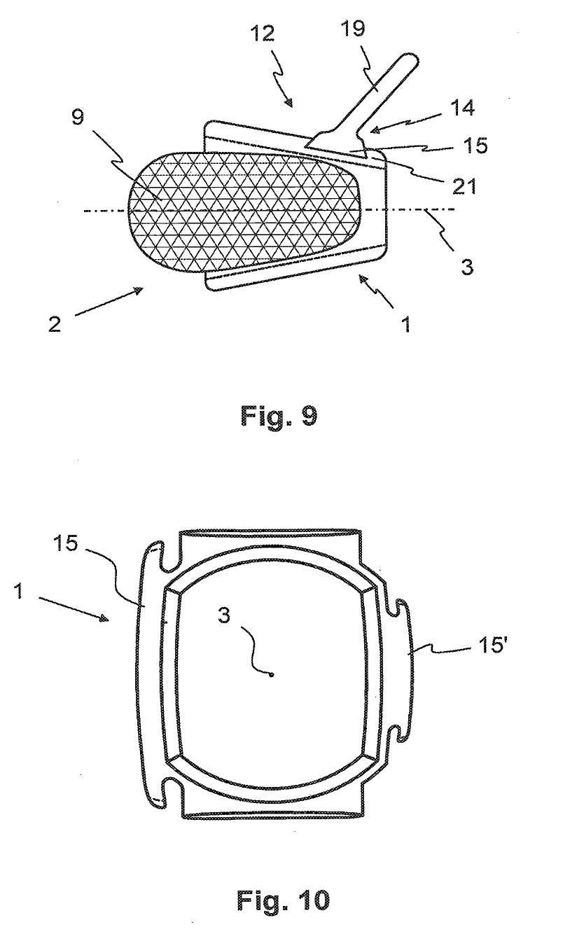

FIG. 9 shows a side view of the teeth-cleaning system according to an alternative embodiment, and

FIG. 10 shows a top view of the main body according to a first exemplary embodiment similar to FIG. 1.

FIG. 1 shows a main body 1 for a teeth-cleaning system 2 according to the following FIGS. 3, 4, 6, 7, and 9. The main body 1 comprises a recess 4 extending in a longitudinal direction 3 for accommodating a fingertip (not represented). In FIG. 1, the longitudinal direction 3 extends into the sheet plane. The main body 1 is designed to be annular. The main body 1 can also be designed to be U-shaped (cf. FIG. 8).

The recess 4 comprises a conically shaped inner surface 5 and, therefore, a first recess opening 6 is smaller than a second recess opening 7 offset along the longitudinal direction 3. Therefore, the recess 4 is designed to be essentially complementary to the finger. It would be conceivable that the recess 4 comprises only the first recess opening 6 and is designed in the shape of a thimble. The two recess openings 6, 7 can also have the same size, and so the recess is cylindrically shaped.

Recesses 4 having different sizes are made available for different finger shapes. Moreover, the inner surface 5 is designed to be polygonal, and so the main body 1 and, therefore, the teeth-cleaning system 2 according to FIGS. 3 and 4, is held in a rotatably fixed manner on the finger, in particular, the index finger.

The main body 1 has several, preferably four, sides. A first grip surface 9 is situated on each of two opposite sides. The two first grip surfaces 9 are provided for controlling the movement of the main body or of the teeth-cleaning system (cf. FIGS. 3, 4, 6, 7, and 9) in the oral cavity. Preferably, the thumb and the middle finger engage on the two first grip surfaces 9 in order to hold the main body 1. The two first grip surfaces 9 form a wing-type surface which projects over the main body 1. The first grip surface 9 extends along the longitudinal direction 3 of the main body 1.

A second grip surface 10 is provided between the two first grip surfaces 9. The second grip surface 10 is utilized as a further control surface for the thumb. One or several grip surfaces can include a non-slip surface in order to improve the feel during the handling. The grip surfaces 9, 10 can be curved, perforated, and/or ribbed.

The main body 1 comprises at least one slot 11 on its side opposite the second grip surface 10. The slot 11 is designed for connecting the main body 1 to a holder 12 of the teeth-cleaning system 1. The slot 11 and the holder 12 are designed to be complementary to one another in such a way that the holder 12 can be at least partially accommodated by the slot.

The main body 1 comprises a first part 13 of a fastening system 14 (cf. FIGS. 3 and 4), with the aid of which the holder 12 can be positioned on the main body 1. According to FIG. 1, the first part 13 of the fastening system 14 is a fastening carriage 15. The fastening carriage 15 comprises a first guide surface 16 which is designed to be U-shaped. The fastening carriage 15 tapers in the longitudinal direction 3, as is represented in FIG. 1 with the aid of a dashed line 17. The fastening carriage 15 is therefore essentially conical, and so the widening area ensures that the fastening carriage 15 is braced against an area of the holder 12 provided therefor (cf. FIGS. 3 and 4).

FIG. 2 shows the holder 12 for the teeth-cleaning system 2 (cf. FIGS. 3, 4, 6, 7, and 9), which is designed, in particular, for connection to the main body 1 (cf. FIGS. 1, 8) and for tensioning dental floss 18. The holder 12 comprises two mutually spaced brackets 19, between which the dental floss 18 is held. The dental floss 18 is connected to the brackets 19 with the aid of at least one fastening element 22. Thus, for example, the dental floss 18 can be wound around the fastening element 22 and/or clamped therein. The dental floss 18 can also be fixedly connected to the brackets 19 or embedded therein, as is represented in FIGS. 3 and 4.

The holder 12 comprises a second part 20 of the fastening system 14, and so the holder 12 can be connected to the main body 1 (cf. FIGS. 1, 8) in a force-locked and/or form-locking manner. According to the present exemplary embodiment, the second part 20 of the fastening system 14 is a fastening rail 21 for accommodating the fastening carriage 15 of the main body 1. The fastening rail 21 comprises a second guide surface 23. The second guide surface 23 is designed to be U-shaped, and so the fastening carriage 15 of the main body 1 can be accommodated therein. A spring 24 is formed on the fastening rail 21, which engages into the slot 11 of the main body 1, and so, essentially, a groove-spring connection can be formed.

Between the two brackets 19 and the dental floss 18, a stop 26 is situated on an inner side 25 of the holder 12, and so the introduction of the dental floss 18 into the interdental space is limited. Holders 12 can be provided with different stops 26 or no stops 26 in order to ensure a gentle handling without injuring the individual gum.

The surface of the fastening carriage 15 (FIG. 1) has a convexity having a small radius r. The corresponding surface of the fastening rail 21 (FIG. 2) has a larger radius R, however. If the holder 12 and the main body 1 are connected to one another, a bending of the holder 12 occurs, whereby the two brackets 19 are bent apart from one another. A tensioning of the dental floss 18 results, which considerably facilitates the insertion of the dental floss 18 into the interdental space and the cleaning thereof. Such a movement of the brackets 19 can also be effectuated by way of an appropriate dimensioning of the slots 11 and the springs 24. In order to facilitate the connection of the fastening carriage 15 and the fastening rail 21, it can be provided that a large amount of play is initially provided, which finally decreases and, thus, results in a clamping only upon further insertion of the spring 24 into the slot 11.

FIG. 3 shows the teeth-cleaning system 2 comprising the main body 1 and the holder 12, each according to one alternative embodiment, In contrast to the main body 1 shown in FIG. 1 and the holder 12 shown in FIG. 2, the two guide surfaces 16, 23 are designed in a dovetail shape in this case.

The guide surfaces 16, 23 of the main body 1 and of the holder 12, respectively, are not parallel to one another in the non-assembled state, as is represented in FIGS. 1 and 2, When the holder 12 or its fastening rail 21 is slid onto the fastening carriage 15 or the main body, the holder 12 spreads apart in such a way that the dental floss 18 is tensioned between the brackets 19. Therefore, when the holder 12 and the main body 1 are not connected to one another to form the teeth-cleaning system 2, the dental floss 18 is essentially held loosely between the brackets 19. The dental floss 18 is first tensioned by way of the connection of the two portions 13, 20 of the fastening system, in particular, the connection of the fastening carriage 15 to the fastening rail 21. The tension of the dental floss is established in such a way that an ideal cleaning of the interdental spaces can take place.

According to FIG. 3, the dental floss 18 is fixedly connected to the brackets 19, wherein one end of the dental floss 18 is molded into a bracket 19 in each case. Alternatively, as represented in FIG. 2, the dental floss 18 can be fastened to the holder 12 with the aid of the fastening element, and so the dental floss 18 can be replaced at any time, as necessary. In order to replace the dental floss 18, according to FIG. 3, on the teeth-cleaning system 2, the holder 12 is removed from the teeth-cleaning system 2 and a new holder (not represented) is connected to the main body 1.

The fastening system 14 of the teeth-cleaning system 2 is additionally secured with the aid of a locking mechanism 27 which is merely schematically indicated in FIG. 3. The locking mechanism 27 can be designed, for example, to include a magnet, a snap-in connection, or a push button.

Moreover, a retaining element 28 is installed on the teeth-cleaning system 2, which safeguards the holder 12 and/or the main body 1 against being swallowed. The retaining element 28 is designed as a thread which can be fastened on the hand and is fastened to the holder 12 and/or the main body 1.

FIG. 4 shows a perspective representation of the teeth-cleaning system 2. The main body 1 and the holder 12 are connected to one another by the fastening system 14, in particular, the fastening carriage 15 has been slid into the fastening rail 21. Since the guide surfaces 16, 23 (cf. FIGS. 1 and 2) extend askew with respect to one another, the holder 12 spreads apart on the main body 1 in such a way that the dental floss 18 is tensioned.

The inner surface 5 of the main body is designed to be conical and polygonal, and so the entire teeth-cleaning system 2 is held on the finger in a rotatably fixed manner when the teeth-cleaning system 2 is utilized, in particular, in the oral cavity. Preferably, different sizes and geometries of the teeth-cleaning system 1 are made available for different finger shapes. Thus, smaller teeth-cleaning systems 1 are also suitable for small fingers, wherein, in particular, the recess 4 of the main body 1 is reduced in size.

FIG. 5a shows the holder 12 as well as its second guide surface 23 and FIG. 5b shows the main body 1 comprising the first guide surface 16. The geometry of the second guide surface 23 can differ from the geometry of the first guide surface 16. In this case, the two guide surfaces 16, 23 are not parallel to one another, in particular, when the holder 12 is situated with respect to the main body 1 in such a way that the two guide surfaces 16, 23 face one another, As a result, a spreading or clamping of the holder 12 on the main body 1 can be achieved.

As is also described according to FIG. 1, the first guide surface 16 is designed to be conical, wherein the fastening carriage 15 describes a first taper angle 29. The second guide surface 16 can also be designed to be conical, although preferably having a smaller second taper angle 30. When the fastening carriage 15 is slid into the fastening rail 21, the larger first guide surface 16, due to its larger first taper angle 29, spreads the smaller second taper angle 30 or the second guide surface apart, and so the dental floss 18 (cf. FIGS. 3, 4, 7, 9) is tensioned.

One of the taper angles 29, 30 can be equal to zero in this case, and so the guide surface is essentially straight.

FIG. 6 shows a side view of the teeth-cleaning system 2 which is equipped with an adjusting mechanism 31. According to FIG. 6, the adjusting mechanism 31 is designed as a size-adjustable tube clamp 32 for varying the diameter of the recess 4. Due to the fact that the tube clamp 32 is fixed, the recess 4 of the main body 1 reduces in size, and so the teeth-cleaning system 2 is suitable for smaller fingers. The main body 1 is provided with a slot 34 in order to make it easy to reduce the size of the main body 1. The diameter of the main body 1 can be reduced by tightening the tube clamp 32.

In addition to the adjusting mechanism 31, FIG. 6 shows that the brackets 19 of the holder 12 are situated obliquely with respect to the fastening rail 21 thereof and with respect to the longitudinal axis 3 of the main body 1.

In FIG. 6, another locking mechanism 27 for the holder 12 on the main body is also represented, in a sketched manner. This is a small tab which snaps into a recess in the main body 1. An inadvertent release of the connection between the main body 1 and the holder 12 is therefore avoided. For the purpose of releasing the connection, it can be provided that the tab breaks at an intended breaking point in order to indicate that the dental floss has already been used and should not be used once again.

FIG. 7 shows that the main body 1 and the holder 12 are connected to one another as one piece to form the teeth-cleaning system 2. The teeth-cleaning system 2 therefore does not comprise a fastening system 14 according to the preceding figures. In order to ensure that the entire teeth-cleaning system 2 does not need to be replaced when the dental floss 18 is replaced, the teeth-cleaning system 2 can comprise a fastening element 22 according to FIG. 2. The fastening element 22 makes it possible to replace only the dental floss 18.

Moreover, an alternative embodiment of the adjusting mechanism is formed in the recess 4, which is a ring insert 33 according to FIG. 7.

The ring insert 33 is separately formed and can be placed into the recess in order to reduce the size of the recess. In this way, the teeth-cleaning system 2 is easily adapted to different finger shapes and sizes.

FIG. 8 shows the main body 1 according to an alternative embodiment, wherein the main body 1 is designed to be U-shaped. The main body 1 comprises a third recess opening 8 which is situated in the area of the fastening carriage 15. It is also conceivable that the recess opening 8 is situated on the other sides of the main body 1.

FIG. 9 shows that the fastening system 14 can also be oriented transversely with respect to the longitudinal direction 3 of the main body. In order to connect the fastening carriage 15 and the fastening rail 21 to one another, the holder 12 is slid onto the main body 1 transversely with respect to the longitudinal direction 3. Due to a predefined, different bending of the fastening carriage 15 and the fastening rail 21 in the insertion direction, a pretensioning of the dental floss arises, since the brackets 19 move away from one another, at the end thereof to which the dental floss is fastened (see FIG. 2). In the relaxed state, before the fastening carriage 15 has been slid into the fastening rail 21, the radius of the fastening carriage 15 is greater than the radius of the fastening rail 21. In contrast to the preceding figures, the main body 1 comprises the fastening rail 21 and the holder 12 comprises the fastening carriage 15. In this FIG. 9, it is also indicated that the surface of the grip surface is structured, specifically, ribbed in this case, in order to improve the guidance of the teeth-cleaning system 2.

FIG. 10 shows a main body 1 similar to FIG. 1. The only difference is that a second fastening carriage 15′ is provided in addition to the fastening carriage 15. The second fastening carriage 15′ is dimensioned smaller in this case and, therefore, is suitable for the accommodation of a smaller holder according to FIG. 2. Of course, a second accommodation similar to the embodiment according to FIG. 9 can also be situated transversely with respect to the longitudinal direction 3 of the main body 1 or even a combination of both types of the accommodation.

The present invention is not limited to the represented and described exemplary embodiments. Modifications within the scope of the claims are also possible, as is any combination of the features, even if they are represented and described in different exemplary embodiments.

### LIST OF REFERENCE CHARACTERS

1 main body
2 teeth-cleaning system
3 longitudinal direction
4 recess
5 inner surface
6 first recess opening
7 second recess opening
8 third recess opening
9 first grip surface
10 second grip surface
11 slot
12 holder
13 first part
14 fastening system
15 fastening carriage
16 first guide surface
17 line
18 dental floss
19 bracket
20 second part
21 fastening rail
22 fastening element
23 second guide surface
24 spring
25 inner side
26 stop
27 locking mechanism
28 retaining element
29 first taper angle
30 second taper angle
31 adjusting mechanism
32 tube clamp
33 ring insert

1. A teeth-cleaning system (2) comprising a holder (12) for dental floss (18), which includes two mutually spaced brackets (19) and dental floss (18) held between the two brackets (19),
and comprising a main body (1) slidable onto a finger, which includes a recess (4) situated in the longitudinal direction (3) of the main body (1) for accommodating a fingertip,
characterized in that
the brackets (19) extend essentially transversely with respect to the longitudinal direction (3) of the main body (1) and a first grip surface (9) is situated at least on each of the two sides of the main body (1), which is provided for controlling the movement of the dental floss (18) in the mouth with the aid of the fingers adjacent to the main body (18).

2. The teeth-cleaning system (2) as in claim 1, characterized in that a further second grip surface (10) for controlling the movement of the dental floss (18) in the mouth with the aid of the thumb is provided on the side of the main body (1) opposite the brackets (19).

3. The teeth-cleaning system (2) as in claim 2, characterized in that at least one of the grip surfaces (9, 10) forms a surface which is wing-like and projects over the main body (1).

4. The teeth-cleaning system (2) as in claim 2, characterized in that at least one of the grip surfaces (9, 10) includes a non-slip, curved, perforated, and/or ribbed surface.

5. The teeth-cleaning system (2) as in claim 1, characterized in that the holder (12) and the main body (1) are designed as one piece or multi-pieced.

6. The teeth-cleaning system (2) as in claim 1, characterized in that the main body (1) includes a slot (11), in particular, for accommodating the holder (12) and/or for adaptation to different finger sizes.

7. The teeth-cleaning system (2) as in claim 1, characterized in that a fastening system (14) connects the holder (12) and the main body (1) to one another.

8. The teeth-cleaning system (2) as in claim 7, characterized in that the holder (12) and the main body (1) each comprise one part (13, 20) of the fastening system (14), wherein the two parts (13, 20) are designed to be complementary to one another in such a way that the dental floss (18) held by the holder (12) is pretensioned, when the holder (12) and the main body (1) are connected to one another.

9. The teeth-cleaning system (2) as in claim 8, characterized in that the fastening system (14) has a form-locking and/or force-locked connection comprising a fastening rail (21) and a fastening carriage (15), a magnetic, threaded, plug-in, adhesive, hook and loop connection, and/or a snap-in connection.

10. The teeth-cleaning system (2) as in claim 1, characterized in that a releasable locking mechanism secures the connection between the holder (12) and the main body (1).

11. The teeth-cleaning system (2) as in claim 9, characterized in that the fastening rail (21) and the fastening carriage (15) taper conically in the longitudinal and/or transverse direction of the main body (1).

12. The teeth-cleaning system (2) as in claim 9, characterized in that the fastening rail (21) and/or the fastening carriage (15) comprise/comprises lateral, guide surfaces (16, 23).

13. The teeth-cleaning system (2) as in claim 12, characterized in that the guide surfaces (16, 23) of the fastening rail (21) and of the fastening carriage (15) are not parallel to one another in the non-assembled state, and so the holder (12), which is connected to the main body (1), is spread apart in the assembled state in such a way that the dental floss (18) is tensioned between the brackets (19).

14. The teeth-cleaning system (2) as in claim 1, characterized in that a retaining element (28), in particular, a thread, safeguards the holder (12) and/or the main body (1) against being swallowed.

15. The teeth-cleaning system (2) as in claim 1, characterized in that a stop (26) is situated on the holder (12) and/or on the main body (1), in an area between the two brackets (19), the dental floss (18), and the main body (1), and so the depth of the introduction of the dental floss (18) into an interdental space is limited in a vertical direction.

16. The teeth-cleaning system (2) as in claim 15, characterized in that the stop (26) is formed by the surface of the main body (1) or of the holder (12) opposite the dental floss (18) and the depth of the introduction is determined by the length of the brackets (19).

17. The teeth-cleaning system (2) as in claim 1, characterized in that the holder (12) and/or the main body (1) comprise/comprises a fastening element (22) for fastening dental floss (18).

18. The teeth-cleaning system (2) as in claim 1, characterized in that the holder (12) and/or the main body (1) include/includes a coding, for designating a certain size and/or dental floss (18).

19. A main body (1) for a teeth-cleaning system (2) according to claim 1, which is slidable onto a finger, and which comprises a recess (4) situated in the longitudinal direction (3) of the main body (1) for accommodating a fingertip,
characterized in that
a first grip surface (9) is situated at least on each of the two sides of the main body (1), which is provided for controlling the movement of dental floss (18) in the mouth with the aid of the fingers adjacent to the main body (1).

20. The main body (1) as in claim 19, characterized in that one further second grip surface (10) for controlling the movement of the dental floss (18) in the mouth with the aid of the index finger is provided between the two lateral grip surfaces (9).

21. The main body (1) as in claim 20, characterized in that at least the two lateral grip surfaces (9) form a surface which is, in particular, wing-like and/or projects over the main body (1).

22. The main body (1) as in claim 19, characterized in that a first part (13) of a form-locking and/or force-locked fastening system (14) for accommodating a holder (12) for dental floss (18) comprises a fastening rail (21) or a fastening carriage (15), a part of a magnetic, threaded, plug-in, adhesive, hook and loop connection, and/or a part of a snap-in connection for connecting the main body (1) to a holder (12) for dental floss (18) is formed on the main body (1).

23. The main body (1) as in claim 19, characterized in that the recess (4) is designed to be conical and/or flattened, and so the teeth-cleaning system (2) can be held on the finger in a rotatably fixed manner.

24. The main body (1) as in claim 19, characterized in that the main body (1) includes a slot (11), for accommodating the holder (12) and/or for adaptation to different finger sizes.

25. The main body (1) as in claim 19, characterized in that the main body (1) is U-shaped or is designed on its periphery as a closed or open ring and/or as a thimble.

26. A holder (12) for dental floss (18) for a teeth-cleaning system (2) as in claim 1, comprising
two mutually spaced brackets (19) and dental floss (18) held between the two brackets (19),
characterized in that
the holder (12) comprises a second part (20) of a form-locking and/or force-locked fastening system (14), comprising a fastening carriage (15) or a fastening rail (21), to be accommodated in a main body (1) of the teeth-cleaning system (2), and/or a part of a magnetic, threaded, plug-in, adhesive, hook and loop connection and/or a part of a snap-in connection for connecting the holder (12) to a main body (1) of the teeth-cleaning system, and the holder (12) is designed in such a way that it spreads apart in such a way that the dental floss (18) is tensioned between the brackets (19) when the holder (12) is fastened on the main body (1).

27. The holder (12) as in claim 26, characterized in that the fastening system (14) is situated longitudinally and/or transversely with respect to the orientation of the dental floss (18).

28. The holder (12) as in claim 26, characterized in that a stop (26) is situated on an inner side of the holder (12) formed between the two brackets (19) and the dental floss (18), and so the introduction of the dental floss (18) into an interdental space is limited in a vertical direction.
